(19) United States
(12) Patent Application Publication
(10) Pub. No.: US 2020/0061991 A1
(43) Pub. Date: Feb. 27, 2020

(54) LIQUID EJECTING HEAD AND LIQUID EJECTING APPARATUS

(71) Applicant: SEIKO EPSON CORPORATION, Tokyo (JP)

(72) Inventor: Shunya Fukuda, Azumino-shi (JP)

(21) Appl. No.: 16/549,211

(22) Filed: Aug. 23, 2019

(30) Foreign Application Priority Data
Aug. 27, 2018 (JP) 2018-158071
Feb. 22, 2019 (JP) 2019-030392

(51) Int. Cl. B41J 2/055; B41J 2/14

(52) U.S. Cl. CPC B41J 2/055; B41J 2002/14491; B41J 2002/14241; B41J 2/14233

(57) ABSTRACT

A liquid ejecting head includes an ejecting unit including first and second pressure chambers respectively communicating with first and second nozzles that eject a liquid, a first wall portion separating the first and second pressure chambers, first and second driving elements that respectively vary pressures of the first and second pressure chambers; a protection substrate disposed at the ejecting unit on a side opposite to the first and second nozzles; and a support portion formed to extend from a surface of the protection substrate on a side near the ejecting unit to the ejecting unit. The support portion overlaps the first wall portion in plan view in a direction perpendicular to the protection substrate, and a portion of the support portion that is in contact with a surface of the ejecting unit has a larger width than a width of the first wall portion.

The present application is based on, and claims priority from JP Application Serial Number 2018-158071, filed Aug. 27, 2018 and JP Application Serial Number 2019-030392, filed Feb. 22, 2019, the disclosures of which are hereby incorporated by reference herein in their entirety.

### BACKGROUND

### 1. Technical Field

The present disclosure relates to a technology that ejects liquid such as ink.

### 2. Related Art

A liquid ejecting head that ejects liquid such as ink from a plurality of nozzles has been suggested. For example, JP-A-2012-61750 discloses an ink jet head including a channel substrate having individual liquid chambers separated by liquid-chamber partition walls and communicating with nozzles that eject ink. Piezoelectric elements vary the pressure in the individual liquid chambers and thus ink is ejected from the nozzles communicating with the individual liquid chambers.

However, with the technology in JP-A-2012-61750, the liquid-chamber partition walls are deformed due to the variation in the pressure in the individual liquid chambers, resulting in occurrence of a phenomenon in which the pressure of the individual liquid chambers adjacent to each other with the liquid-chamber partition wall interposed therebetween varies (hereinafter, referred to as “crosstalk”). Thus, an error occurs in ejection characteristics, such as an ink ejection amount or an ejection speed.

### SUMMARY

To address the above-described problem, a liquid ejecting head according to an aspect of the present disclosure includes an ejecting unit including a first pressure chamber communicating with a first nozzle that ejects a liquid, a second pressure chamber communicating with a second nozzle that ejects the liquid, a first wall portion separating the first pressure chamber and the second pressure chamber, a first driving element that varies a pressure of the first pressure chamber, and a second driving element that varies a pressure of the second pressure chamber; a protection substrate disposed at the ejecting unit on a side opposite to the first nozzle and the second nozzle; and a support portion formed to extend from a surface of the protection substrate on a side near the ejecting unit to the ejecting unit. The support portion overlaps the first wall portion in plan view in a direction perpendicular to the protection substrate, and a portion of the support portion that is in contact with a surface of the ejecting unit has a larger width than a width of the first wall portion.

### BRIEF DESCRIPTION OF THE DRAWINGS

FIG. 1 is a configuration diagram of a liquid ejecting apparatus according to a first embodiment.

FIG. 2 is an exploded perspective view of a liquid ejecting head.

FIG. 3 is a sectional view of the liquid ejecting head.

FIG. 4 is a sectional view taken along line IV-IV in FIG. 3.

FIG. 5 is a sectional view of a liquid ejecting head according to another example of the first embodiment.

FIG. 6 is a sectional view of a liquid ejecting head according to a second embodiment.

FIG. 7 is a sectional view of a liquid ejecting head according to a third embodiment.

FIG. 8 is a sectional view of a liquid ejecting head according to a fourth embodiment.

FIG. 9 is a waveform diagram of a reference voltage and a drive waveform according to a fifth embodiment.

FIG. 10 is a plan view of a plurality of liquid ejecting heads according to a sixth embodiment.

FIG. 11 is a plan view of a plurality of liquid ejecting heads according to a seventh embodiment.

### DESCRIPTION OF EXEMPLARY EMBODIMENTS

### First Embodiment

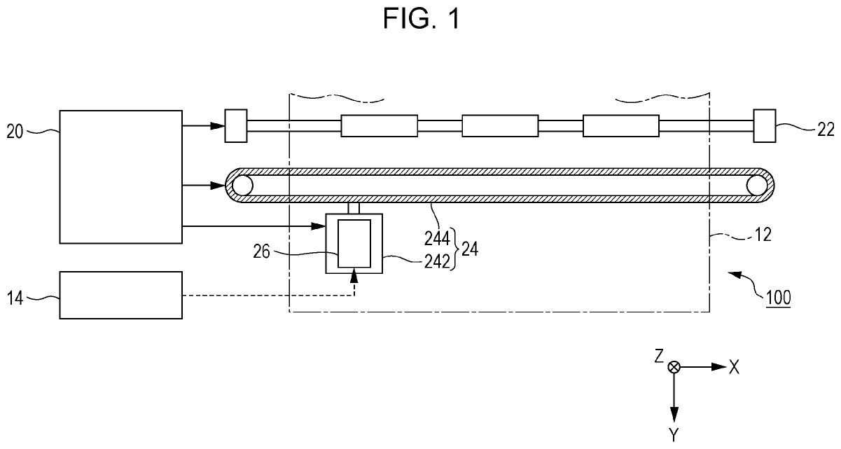

FIG. 1 is a configuration diagram of a liquid ejecting apparatus 100 according to a first embodiment of the disclosure. The liquid ejecting apparatus 100 according to this embodiment is an ink jet printing apparatus that ejects an ink, which is an example of a liquid, onto a medium (ejection object) 12. The medium 12 is typically a printing sheet of paper; however, a printing object of any material, such as a resin film or a fabric, is used as the medium 12. As illustrated in FIG. 1, a liquid container 14 for storing the ink is disposed in the liquid ejecting apparatus 100. For example, a cartridge attachable/detachable to/from the liquid ejecting apparatus 100, a bag-shaped ink pack formed of a flexible film, or an ink tank capable of being refilled with the ink may be used as the liquid container 14.

As illustrated in FIG. 1, the liquid ejecting apparatus 100 includes a control unit 20, a transport mechanism 22, a movement mechanism 24, and a liquid ejecting head 26. The control unit 20 includes, for example, a processing circuit, such as a central processing unit (CPU) or a field programmable gate array (FPGA), and a memory circuit such as a semiconductor memory. The control unit 20 centrally controls the elements of the liquid ejecting apparatus 100. The transport mechanism 22 transports the medium 12 in the Y direction under the control of the control unit 20.

The movement mechanism 24 reciprocates the liquid ejecting head 26 in the X direction under the control of the control unit 20. The X direction is a direction orthogonal to the Y direction in which the medium 12 is transported. Typically, the X direction is a direction orthogonal to the Y direction. The movement mechanism 24 according to the first embodiment includes a substantially box-shaped transport body 242 that houses the liquid ejecting head 26, and a transport belt 244 to which the transport body 242 is fixed. Alternatively, a configuration in which a plurality of liquid ejecting heads 26 are mounted at the transport body 242 or a configuration in which the liquid container 14 is mounted at the transport body 242 together with the liquid ejecting head 26 may be also employed.

The liquid ejecting head 26 ejects the ink supplied from the liquid container 14 onto the medium 12 from a plurality of nozzles under the control of the control unit 20. Each liquid ejecting head 26 ejects the ink onto the medium 12 in synchronization with the transport of the medium 12 by the transport mechanism 22 and the repetitive reciprocation of the transport body 242. Thus, a desirable image is formed on a surface of the medium 12.

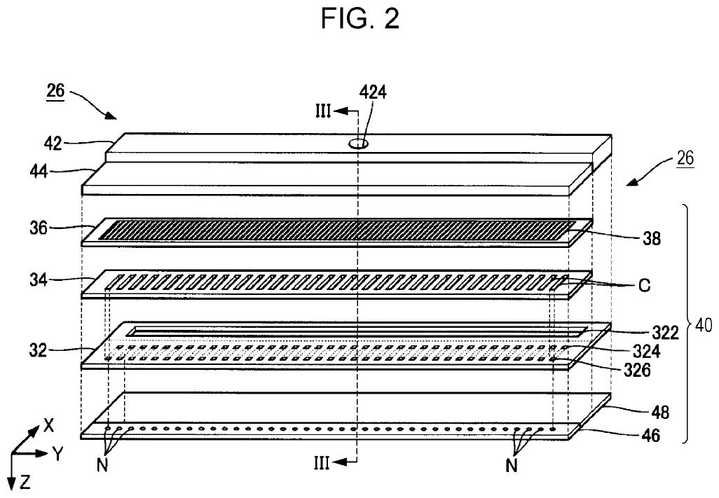

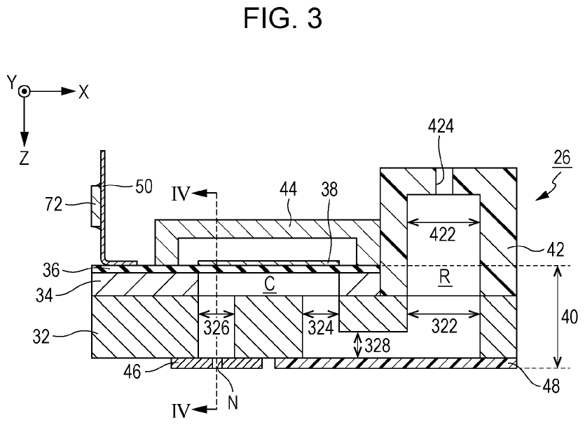

FIG. 2 is an exploded perspective view of the liquid ejecting head 26, and FIG. 3 is a sectional view taken along line III-III in FIG. 2. As illustrated in FIG. 2, the direction perpendicular to the X-Y plane is hereinafter referred to as the Z direction. The ejection direction of the ink by each liquid ejecting head 26 corresponds to the Z direction. Typically, the Z direction is the vertical direction. The X-Y plane is, for example, a plane parallel to the surface of the medium 12.

As illustrated in FIGS. 2 and 3, the liquid ejecting head 26 includes an ejecting unit 40 that ejects a liquid from nozzles N. The ejecting unit 40 includes a channel substrate 32, a pressure chamber substrate 34, a vibrating plate 36, a plurality of piezoelectric elements 38, a nozzle plate 46, and a vibration absorber 48. The channel substrate 32 is a plate-shaped member having a substantially rectangular shape long in the Y direction. The pressure chamber substrate 34, the vibrating plate 36, the plurality of piezoelectric elements 38, a housing 42, and a protection substrate 44 are disposed at the surface of the channel substrate 32 on the negative side in the Z direction. In contrast, the nozzle plate 46 and the vibration absorber 48 are disposed at the surface of the channel substrate 32 on the positive side in the Z direction. The elements of the liquid ejecting head 26 each are a plate-shaped member long in the Y direction generally similarly to the channel substrate 32, and are bonded to one another by using, for example, an adhesive.

As illustrated in FIG. 2, the nozzle plate 46 is a plate-shaped member in which a plurality of nozzles N arranged in the Y direction are formed. Each nozzle N is a through hole through which the ink passes. The channel substrate 32, the pressure chamber substrate 34, and the nozzle plate 46 are formed by processing, for example, a single crystal substrate of silicon (Si) by a semiconductor manufacturing technique such as etching. However, the materials and manufacturing methods of the elements of the liquid ejecting head 26 are desirably determined. The Y direction may be also referred to as a direction in which the plurality of nozzles N are arranged.

The channel substrate 32 is a plate-shaped member for forming a channel of the ink. As illustrated in FIGS. 2 and 3, an opening 322, a supply channel 324, and a communication channel 326 are formed in the channel substrate 32. The opening 322 is a through hole formed in a long shape along the Y direction in plan view in the Z direction so as to be continuous over the plurality of nozzles N. The supply channel 324 and the communication channel 326 are through holes formed for each of the nozzles N, and cause the nozzle N to communicate with a pressure chamber C. As illustrated in FIG. 3, a relay channel 328 is formed over a plurality of the supply channels 324 in the surface on the positive side in the Z direction of the channel substrate 32. The relay channel 328 is a channel for causing the opening 322 to communicate with the plurality of supply channels 324.

The housing 42 is a structure manufactured by, for example, injection molding using a resin material, and is fixed to the surface on the negative side in the Z direction of the channel substrate 32. As illustrated in FIG. 3, a housing portion 422 and an inlet 424 are formed in the housing 42. The housing portion 422 is a recessed portion having an outer shape corresponding to the opening 322 of the channel substrate 32, and the inlet 424 is a through hole communicating with the housing portion 422. As understood from FIG. 3, the space in which the opening 322 of the channel substrate 32 and the housing portion 422 of the housing 42 communicate with each other functions as a liquid storage chamber (reservoir) R. The ink supplied from the liquid container 14 and passed through the inlet 424 is stored in the liquid storage chamber R.

The vibration absorber 48 is an element for absorbing a pressure variation in the liquid storage chamber R. The vibration absorber 48 includes, for example, a flexible sheet member (compliance substrate) that is elastically deformable. To be specific, the vibration absorber 48 is disposed at the surface on the positive side in the Z direction of the channel substrate 32 so as to define a bottom surface of the liquid storage chamber R by closing the opening 322, the relay channel 328, and the plurality of supply channels 324 of the channel substrate 32.

As illustrated in FIGS. 2 and 3, the pressure chamber substrate 34 is a plate-shaped member in which a plurality of pressure chambers C corresponding to mutually different nozzles N are formed. The plurality of pressure chambers C are arranged along the Y direction. Each pressure chamber C (cavity) is a long opening extending along the X direction in plan view. The end portion of a pressure chamber C on the positive side in the X direction overlaps a single supply channel 324 of the channel substrate 32 in plan view. The end portion of the pressure chamber C on the negative side in the X direction overlaps a single communication channel 326 of the channel substrate 32 in plan view.

The vibrating plate 36 is disposed at the surface of the pressure chamber substrate 34 on the side opposite to the channel substrate 32. The vibrating plate 36 is an elastically deformable plate-shaped member. The vibrating plate 36 is constituted of, for example, lamination of a first layer formed of silicon dioxide (SiO₂) and a second layer formed of zirconium dioxide (ZrO₂).

As understood from FIG. 3, the channel substrate 32 and the vibrating plate 36 face each other at a distance from each other inside each pressure chamber C. The pressure chamber C is positioned between the channel substrate 32 and the vibrating plate 36 and is a space for applying a pressure to the ink filled in the pressure chamber C. The ink stored in the liquid storage chamber R is branched from the relay channel 328 to the respective supply channels 324, and is simultaneously supplied to and filled in the plurality of pressure chambers C. Each pressure chamber C communicates with the corresponding nozzle N via the channel substrate 32. As understood from the above description, the vibrating plate 36 defines a portion of wall surfaces of the pressure chamber C. To be specific, the vibrating plate 36 defines upper surfaces of the pressure chambers C.

As illustrated in FIGS. 2 and 3, the plurality of piezoelectric elements 38 corresponding to the mutually different nozzles N are disposed at the surface of the vibrating plate 36 on the side opposite to the pressure chambers C. Each piezoelectric element 38 is a driving element that varies the pressure of the corresponding pressure chamber C. To be specific, the piezoelectric element 38 is an actuator that is deformed when a drive waveform is supplied thereto, and is formed in a long shape along the X direction in plan view. The plurality of piezoelectric elements 38 are arranged in the Y direction so as to correspond to the plurality of pressure chambers C. When the vibrating plate 36 vibrates in conjunction with deformation of one of the piezoelectric elements 38, the pressure in the corresponding pressure chamber C varies, and hence the ink filled in the pressure chamber C is ejected through the corresponding communication channel 326 and nozzle N.

The protection substrate 44 illustrated in FIGS. 2 and 3 is a plate-shaped member that protects the plurality of piezoelectric elements 38 and reinforces the mechanical strength of the pressure chamber substrate 34 and the vibrating plate 36. The protection substrate 44 is disposed at the surface of the ejecting unit 40 on the side opposite to the plurality of nozzles N. The plurality of piezoelectric elements 38 are provided between the protection substrate 44 and the vibrating plate 36. The protection substrate 44 is formed of, for example, silicon (Si). In the first embodiment, a distance D between the protection substrate 44 and the vibrating plate 36 is constant in a direction parallel to the vibrating plate 36 (that is, Y direction). The distance D between the protection substrate 44 and the vibrating plate 36 is a distance from the surface of the protection substrate 44 on the side near the ejecting unit 40 to the surface of the vibrating plate 36 on the side near the ejecting unit 40.

As illustrated in FIG. 3, for example, a wiring substrate 50 is bonded to the surface of the vibrating plate 36. The wiring substrate 50 is a surface mounted component having a plurality of wires (not illustrated) for electrically coupling the control unit 20 or a power supply circuit (not illustrated) to the liquid ejecting head 26. For example, a flexible wiring substrate 50, such as a flexible printed circuit (FPC) or a flexible flat cable (FFC), may be suitably employed. As illustrated in FIG. 3, the liquid ejecting head 26 includes a drive circuit 72 that is mounted at the wiring substrate 50. The drive circuit 72 supplies a voltage to each piezoelectric element 38 for driving the piezoelectric element 38.

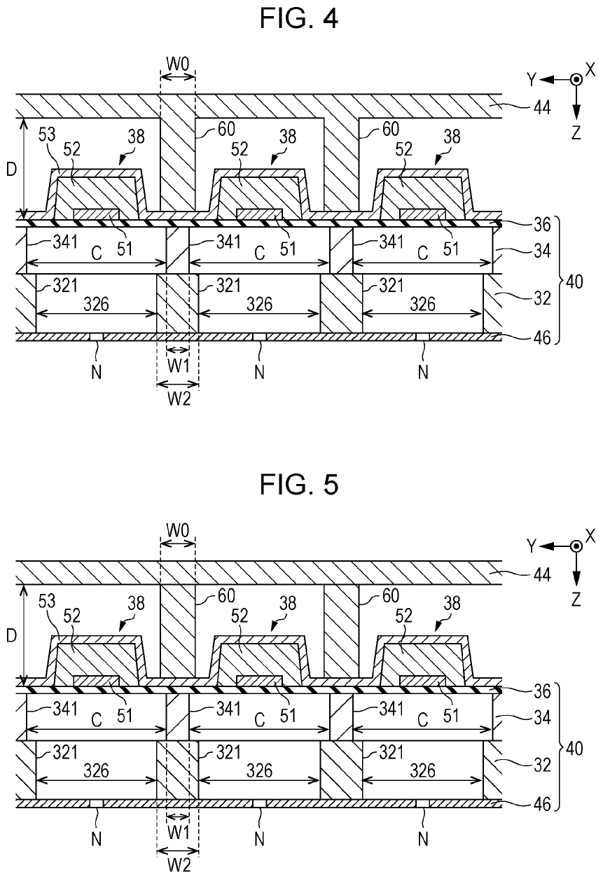

FIG. 4 is a sectional view taken along line IV-IV in FIG. 3. As illustrated in FIG. 4, the piezoelectric element 38 is generally constituted of lamination of a first electrode 51, a piezoelectric layer 52, and a second electrode 53, and is a thin-film active element. In the specification, an expression “an element A and an element B are stacked on one another” is not limited to a configuration in which an element A and an element B are in direct contact with each other. That is, the concept “an element A and an element B are stacked on one another” includes a configuration in which another element C is interposed between an element A and an element B″. In addition, an expression “an element B is formed at a surface of an element A” is not limited to a configuration in which an element A is in direct contact with an element B. That is, the concept “an element B is formed at a surface of an element B” includes a configuration in which an element C is formed at a surface of an element A and an element B is formed at a surface of the element C, as far as at least a portion of the element A overlaps at least a portion of the element B in plan view.

The first electrode 51 is formed at the surface of the vibrating plate 36. The first electrode 51 is an individual electrode formed at a distance from another first electrode 51 for each of the piezoelectric elements 38. To be specific, a plurality of the first electrodes 51 each extending in the X direction are arranged and mutually spaced apart in the Y direction. To the first electrode 51 of each piezoelectric element 38, a drive waveform for controlling ejection of the ink from the nozzle N corresponding to the piezoelectric element 38 is applied via the wiring substrate 50. The piezoelectric layer 52 is formed at a surface of the first electrode 51 by using, for example, a ferroelectric piezoelectric material such as lead zirconate titanate. The second electrode 53 is formed at a surface of the piezoelectric layer 52. To be specific, the second electrode 53 is a strip-shaped common electrode that extends in the Y direction so as to be continuous over the plurality of piezoelectric elements 38. A predetermined reference voltage is applied to the second electrode 53.

The piezoelectric layer 52 is deformed in accordance with the voltage difference between the drive waveform supplied to the first electrode 51 and the reference voltage applied to the second electrode 53. That is, a portion in which the first electrode 51 faces the second electrode 53 with the piezoelectric layer 52 interposed therebetween functions as a piezoelectric element 38. The piezoelectric element 38 is individually formed for each pressure chamber C. To be specific, the plurality of piezoelectric elements 38 each formed to be long in the X direction are arranged and mutually spaced apart in the Y direction. Each piezoelectric element 38 has a smaller dimension in the Y direction (that is, width) than the dimension in the Y direction of the pressure chamber C.

As illustrated in FIG. 4, the pressure chamber substrate 34 has a wall portion 341 separating mutually adjacent pressure chambers C. The wall portion 341 is an example of a first wall portion. In the first embodiment, the wall portion 341 has a width W1 that is constant entirely in the Z direction. The dimension of the wall portion 341 in the Y direction is the width W1 of the wall portion 341.

The liquid ejecting head 26 includes a support portion 60 formed to extend from the surface of the protection substrate 44 on the side near the ejecting unit 40 to the ejecting unit 40. The surface of the support portion 60 on the side near the ejecting unit 40 is bonded to the surface of the ejecting unit 40 by using, for example, an adhesive. To be specific, the support portion 60 according to the first embodiment is in contact with a surface of the second electrode 53 of the ejecting unit 40. In the first embodiment, the support portion 60 and the protection substrate 44 are integrally formed using the same material.

The support portion 60 is formed to overlap the wall portion 341 in plan view in the Z direction perpendicular to the protection substrate 44. To be specific, the support portion 60 is formed to extend from the protection substrate 44 to the surface of the second electrode 53 of the piezoelectric element 38. That is, one end portion of the support portion 60 is in contact with the surface of the protection substrate 44 and the other end portion thereof is in contact with the surface of the ejecting unit 40. To be specific, the other end portion of the support portion 60 is in contact with a surface of a portion of the second electrode 53 not formed with the piezoelectric layer 52. As illustrated in FIG. 4, the support portion 60 and the wall portion 341 face each other with a portion of the vibrating plate 36 not formed with the piezoelectric layer 52 interposed therebetween. The piezoelectric element 38 is disposed between support portions 60 adjacent to each other. The thermal conductivity of the support portion 60 is higher than the thermal conductivity of the piezoelectric layer 52. Thus, for example, the heat generated by the piezoelectric element 38 is released via the support portion 60.

In the first embodiment, the support portion 60 has a width W0 that is constant entirely in the Z direction. The dimension of the support portion 60 in the Y direction is the width W0 of the support portion 60. As illustrated in FIG. 4, the width W0 of the support portion 60 is larger than the width W1 of the wall portion 341. In view in the Z direction, the wall portion 341 is located between the wall surface on one side and the wall surface on the other side in the Y direction of the support portion 60.

The channel substrate 32 includes a wall portion 321 separating mutually adjacent communication channels 326. The wall portion 321 is an example of a second wall portion. The wall portion 321 is formed to overlap the wall portion 341 in plan view in the Z direction perpendicular to the protection substrate 44. One end portion (the end portion on the negative side in the Z direction) of the wall portion 341 is in contact with the vibrating plate 36, and the other end portion (the end portion on the positive side in the Z direction) is in contact with the wall portion 321. In the first embodiment, the wall portion 321 has a width W2 that is constant entirely in the Z direction. The dimension of the wall portion 321 in the Y direction is the width W2 of the wall portion 321. As illustrated in FIG. 4, the width W2 of the wall portion 321 is larger than the width W1 of the wall portion 341. In view in the Z direction, the wall portion 341 is located between the wall surface on one side and the wall surface on the other side in the Y direction of the wall portion 321. That is, in the first embodiment, the wall portion 341 entirely overlaps the support portion 60 and the wall portion 321 in plan view in the Z direction.

Two mutually adjacent pressure chambers C are expressed as a first pressure chamber communicating with a first nozzle that ejects a liquid, and a second pressure chamber communicating with a second nozzle that ejects the liquid. In addition, two mutually adjacent communication channels 326 are expressed as a first communication channel causing the first nozzle to communicate with the first pressure chamber, and a second communication channel causing the second nozzle to communicate with the second pressure chamber. That is, the ejecting unit 40 according to the first embodiment is expressed as an element including the first pressure chamber, the second pressure chamber, a first driving element that varies the pressure of the first pressure chamber, a second driving element that varies the pressure of the second pressure chamber, the wall portion 341 separating the first pressure chamber and the second pressure chamber, the first communication channel, the second communication channel, and the wall portion 321 separating the first communication channel and the second communication channel.

In this case, in a configuration in which the liquid ejecting head 26 does not include the support portion 60 (hereinafter, referred to as “first comparative example”), the wall portion 341 is deformed due to a variation in pressure of the pressure chamber C, and crosstalk may occur in the mutually adjacent pressure chambers C with the wall portion 341 interposed therebetween. With the occurrence of crosstalk, an error occurs in ejection characteristics. In contrast, according to the first embodiment, the support portion 60 that overlaps the wall portion 341 in plan view in the direction perpendicular to the protection substrate 44 is formed. Thus, the support portion 60 can suppress deformation of the wall portion 341. That is, the support portion 60 supports the wall portion 341. Thus, as compared with the first comparative example, crosstalk that occurs in the mutually adjacent pressure chambers C can be reduced.

In particular, according to the first embodiment, the width W0 of the support portion 60 is larger than the width W1 of the wall portion 341. Thus, as compared with a configuration in which the width W0 of the support portion 60 is smaller than the width W1 of the wall portion 341, a noticeable advantageous effect is attained such that deformation of the wall portion 341 can be suppressed. In addition, according to the first embodiment, since the wall portion 321 is formed to overlap the wall portion 341 in plan view in the Z direction perpendicular to the protection substrate 44, the support portion 60 and the wall portion 321 can suppress deformation of the wall portion 341. Thus, a noticeable advantageous effect is attained such that the crosstalk can be reduced. Furthermore, since the width W2 of the wall portion 321 is larger than the width W1 of the wall portion 341, a noticeable advantageous effect is attained such that deformation of the wall portion 341 can be suppressed. It is to be noted that the configuration in which the width W2 of the wall portion 321 is larger than the width W1 of the wall portion 341 is not essential.

As illustrated in FIG. 5, the support portion 60 may be formed separately from the protection substrate 44. For example, the support portion 60 is bonded to the ejecting unit 40 and the protection substrate 44 using an adhesive. The support portion 60 is formed of, for example, a metal, and is harder than the protection substrate 44. To be specific, the Young's modulus of the support portion 60 is larger than the Young's modulus of the protection substrate 44. With the above-described configuration, deformation of the wall portion 341 can be suppressed. Alternatively, the support portion 60 may be softer than the protection substrate 44. In addition, the support portion 60 may be formed of a photosensitive resin that is hardened when irradiated with light. With the configuration in which the support portion 60 is formed of the photosensitive resin, the position of the support portion 60 with respect to the protection substrate 44 can be highly precisely determined.

### Second Embodiment

A second embodiment is described. Note that, for the elements in the following examples having functions similar to those in the first embodiment, the reference numerals used in the description of the first embodiment are used and the detailed description thereof is omitted.

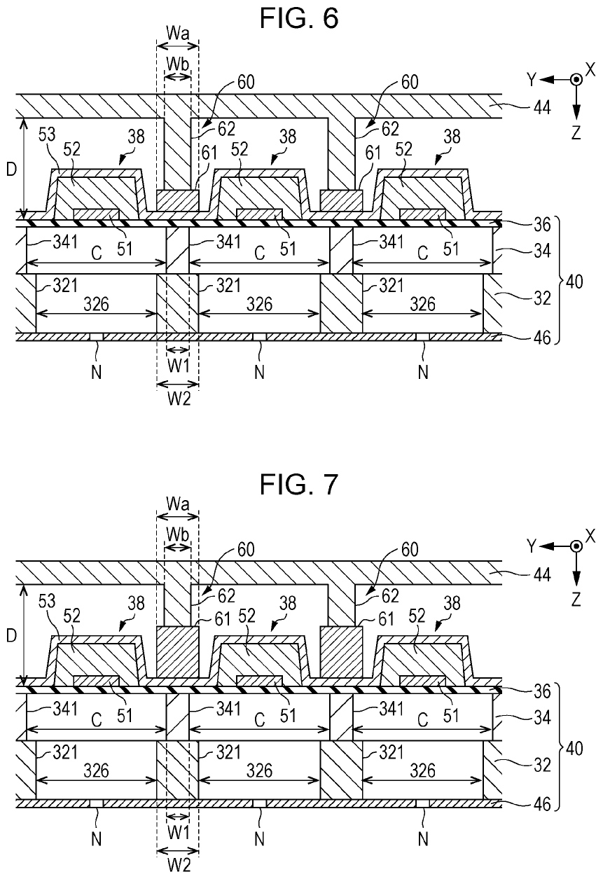

FIG. 6 is a sectional view of a liquid ejecting head 26 according to the second embodiment. The configuration of the second embodiment other than a support portion 60 is similar to that of the first embodiment. As illustrated in FIG. 6, the support portion 60 of the second embodiment includes a first portion 61 and a second portion 62. The first portion 61 of the support portion 60 is located near the ejecting unit 40. The second portion 62 of the support portion 60 is located near the protection substrate 44. The first portion 61 is a portion of the support portion 60 that contacts a surface of the ejecting unit 40. The second portion 62 is a portion of the support portion 60 that contacts a surface of the protection substrate 44. The first portion 61 is formed to extend from the surface of the ejecting unit 40 to a position in the middle of the way to the protection substrate 44. To be specific, the first portion 61 is formed to extend from the surface of the ejecting unit 40 such that the height of the upper surface (that is, the position in the Z direction) of the first portion 61 from the surface of the vibrating plate 36 is smaller than the height of the upper surface of the piezoelectric element 38 from the surface of the vibrating plate 36. In contrast, the second portion 62 is formed to extend from a surface of the first portion 61 to the surface of the protection substrate 44. The first portion 61 has a width Wa that is constant entirely in the Z direction, and that is larger than the width W1 of the wall portion 341. The second portion 62 has a width Wb that is constant entirely in the Z direction, and that is smaller than the width Wa of the first portion 61. In this case, the magnitude relationship between the width Wb of the second portion 62 and the width W1 of the wall portion 341 is desirably determined. To form the first portion 61, any of known film forming technologies, such as sputtering or plating, is employed. The second portion 62 and the protection substrate 44 are integrally formed. Alternatively, the second portion 62 and the protection substrate 44 may be separately formed.

Also in the second embodiment, advantageous effects similar to those of the first embodiment are attained. For example, when a configuration is employed in which the width Wa of the first portion 61 of the support portion 60 that is in contact with the surface of the ejecting unit 40 is smaller than the width W1 of the wall portion 341 (hereinafter, referred to as “second comparative example”), it is difficult to sufficiently suppress deformation of the wall portion 341. In contrast, with the configuration according to the second embodiment in which the width Wa of the first portion 61 of the support portion 60 that is in contact with the surface of the ejecting unit 40 is larger than the width W1 of the wall portion 341, deformation of the wall portion 341 can be sufficiently suppressed as compared with the second comparative example. Thus, crosstalk can be reduced. As understood from the above description, in the viewpoint of reducing crosstalk, the configuration in which the entire width of the support portion 60 is larger than the width W1 of the wall portion 341 is not essential as far as the width Wa of the first portion 61 of the support portion 60 that is in contact with the surface of the ejecting unit 40 is larger than the width W1 of the wall portion 341.

### Third Embodiment

FIG. 7 is a sectional view of a liquid ejecting head 26 according to a third embodiment. As illustrated in FIG. 7, a support portion 60 of the third embodiment includes a first portion 61 and a second portion 62 similarly to the second embodiment. However, in the third embodiment, the first portion 61 is formed to extend from the surface of the ejecting unit 40 such that the height of the upper surface (that is, the position in the Z direction) of the first portion 61 from the surface of the vibrating plate 36 is larger than the height of the upper surface of the piezoelectric element 38 from the surface of the vibrating plate 36. The first portion 61 and the second portion 62 are separately formed and bonded to the surface of the ejecting unit 40. Also in the third embodiment, advantageous effects similar to those of the second embodiment are attained.

### Fourth Embodiment

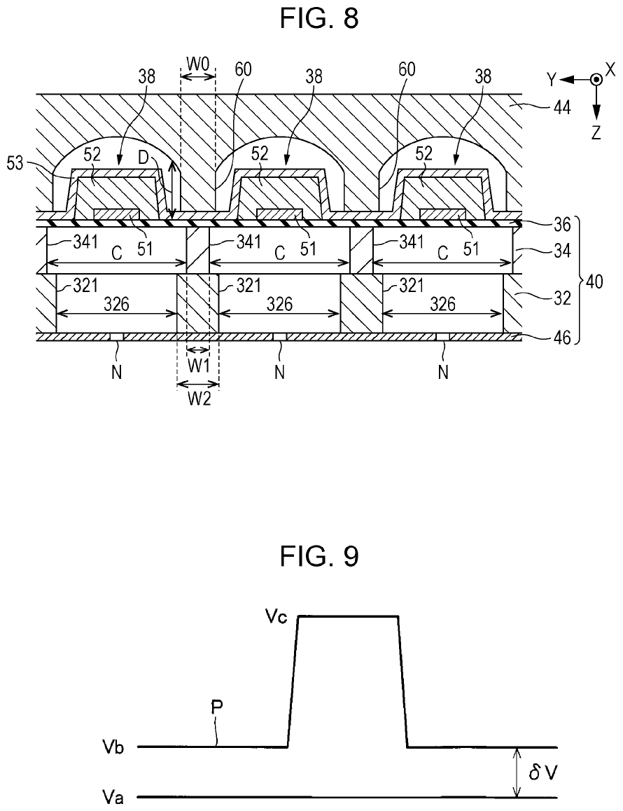

FIG. 8 is a sectional view of a liquid ejecting head 26 according to a fourth embodiment. While the first embodiment has the configuration in which the distance between the protection substrate 44 and the vibrating plate 36 is constant in the Y direction, the fourth embodiment has a configuration in which the distance D between the protection substrate 44 and the vibrating plate 36 varies in the Y direction. The distance D increases the farther away from the support portion 60 in the Y direction. To be specific, the distance D is the minimum at a portion near the support portion 60, and is the maximum at a portion near a center portion of the piezoelectric element 38. For example, as illustrated in FIG. 8, the distance D increases from the portion near the support portion 60 to the portion near the center portion of the piezoelectric element 38 along a curve. Thus, in an area between mutually adjacent support portions 60, the distance D is set such that the surface of the protection substrate 44 on the side near the ejecting unit 40 has an arcuate curved surface from one of the support portions 60 to the other one of the support portions 60.

Also in the fourth embodiment, advantageous effects similar to those of the first embodiment are attained. In the fourth embodiment, since the distance D increases the farther away from the support portion 60 in the Y direction, the support portion 60 can suppress deformation of the wall portion 341 while sufficiently ensuring the space for housing the piezoelectric element 38. As far as the distance D is set to increase the farther away from the support portion 60 in the Y direction, for example, the distance D may increase stepwise from the portion near the support portion 60 to the portion near the center portion of the piezoelectric element 38, or the distance D may linearly increase from the portion near the support portion 60 to the portion near the center portion of the piezoelectric element 38.

### Fifth Embodiment

FIG. 9 is a waveform diagram of a drive waveform P supplied to the first electrode 51 of the piezoelectric element 38, and a reference voltage Va applied to the second electrode 53 of the piezoelectric element 38. As illustrated in FIG. 9, the drive waveform P is a waveform with which its voltage varies from a voltage Vb that differs from the reference voltage Va. To be specific, the drive waveform P includes a period to be held at the voltage Vb and a period to be held at a voltage Vc varied from the voltage Vb. The reference voltage Va is an example of a first voltage and the voltage Vb is an example of a second voltage. The drive waveform P and the reference voltage Va are supplied from the drive circuit 72 to each piezoelectric element 38.

A voltage δV corresponding to the difference between the reference voltage Va and the voltage Vb is constantly applied between the first electrode 51 and the second electrode 53 of each piezoelectric element 38. When the voltage δV is applied and the piezoelectric element 38 is deformed, a stress of pulling or compression constantly acts on the wall portion 341. Thus, comparing with a configuration in which a voltage is not applied to the piezoelectric elements 38 in a situation other than when the drive waveform P is supplied, the wall portion 341 is easily deformed when the drive waveform P is supplied to one of two mutually adjacent piezoelectric elements 38 while the drive waveform P is not supplied to the other one. That is, crosstalk easily occurs. Thus, the configuration of suppressing deformation of the wall portion 341 is particularly effective for the configuration according to the fifth embodiment.

### Sixth Embodiment

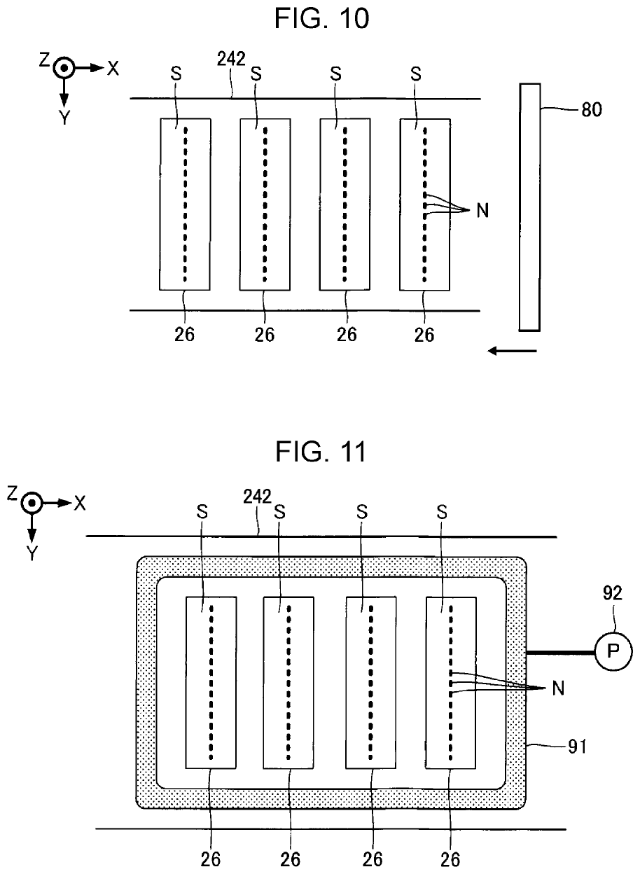

A liquid ejecting apparatus 100 according to a sixth embodiment includes a plurality of liquid ejecting heads 26. Each liquid ejecting head 26 has a configuration similar to that of any one of the above-described embodiments. FIG. 10 is a plan view of the liquid ejecting heads 26 according to the sixth embodiment in plan view from the negative side in the Z direction. In the sixth embodiment, the plurality of liquid ejecting heads 26 are arranged in parallel to one another along the X direction intersecting with the Y direction in which nozzles N are arranged in the liquid ejecting heads 26. Each liquid ejecting head 26 has an ejection surface S in which a plurality of nozzles N are formed. That is, the surface of the nozzle plate 46 on the side opposite to the pressure chambers C serves as the ejection surface S.

As illustrated in FIG. 10, the liquid ejecting apparatus 100 according to the sixth embodiment includes a wiper 80 that wipes ink adhering to each of the ejection surfaces S. The wiper 80 is used for cleaning each of the liquid ejecting heads 26. For example, a plate-shaped member made of an elastic material and formed in a rectangular shape is used as the wiper 80. The wiper 80 wipes the ink on the ejection surface S while the wiper 80 is in contact with the ejection surface S. The control unit 20 causes the wiper 80 to move along the X direction relative to the ejection surface S while the wiper 80 is in contact with the ejection surface S of the liquid ejecting head 26. Thus, the wiper 80 can wipe the ink adhering to the entire area of the ejection surface S.

In the operation of the wiper 80 wiping the ink on the ejection surface S, when the wiper 80 presses the ejection surface S, the vibrating plate 36 or the piezoelectric element 38 may be deformed. Since the support portion 60 is formed at the liquid ejecting head 26 according to the sixth embodiment, deformation of the vibrating plate 36 or the piezoelectric element 38 can be suppressed when the wiper 80 wipes the ink on the ejection surface S. Moreover, with the configuration according to the sixth embodiment in which the number of liquid ejecting heads 26 included in the liquid ejecting apparatus 100 is a plural number, the strength of the liquid ejecting apparatus 100 is increased as compared with a configuration in which the number of liquid ejecting heads 26 included in the liquid ejecting apparatus 100 is one.

### Seventh Embodiment

A liquid ejecting apparatus 100 according to a seventh embodiment includes a plurality of liquid ejecting heads 26 similarly to the sixth embodiment. FIG. 11 is a plan view of the liquid ejecting heads 26 according to the seventh embodiment in plan view from the negative side in the Z direction. As illustrated in FIG. 11, the liquid ejecting apparatus 100 according to the seventh embodiment includes a sealing body 91 and a pump 92. The sealing body 91 and the pump 92 are used for cleaning the liquid ejecting heads 26. The sealing body 91 is in contact with ejection surfaces S and hence seals a plurality of nozzles N of each of the liquid ejecting heads 26. For example, an elastic body that is in close contact with the ejection surfaces S is used as the sealing body 91. The sealing body 91 is in contact with the ejection surfaces S such that the plurality of liquid ejecting heads 26 are located inside an inner peripheral surface of the sealing body 91. The pump 92 sucks the inside of the sealing body 91. To be specific, the pump 92 sucks the ink in the liquid ejecting heads 26 in a state in which the sealing body 91 seals the nozzles N of each of the liquid ejecting heads 26. Thus, the ink can be forcibly ejected from the plurality of nozzles N. To prevent the ink in the liquid ejecting heads 26 from being dried, the sealing body 91 may seal the ejection surfaces S in a standby state in which the liquid ejecting apparatus 100 stops printing.

In the operation of forcibly ejecting the ink from the nozzles N by the sealing body 91 and the pump 92, the vibrating plate 36 or the piezoelectric element 38 may be deformed when sucked by the pump 92. Since the support portion 60 is formed at the liquid ejecting head 26 according to the seventh embodiment, deformation of the vibrating plate 36 or the piezoelectric element 38 can be suppressed when the ink is forcibly ejected.

### Modifications

The embodiments described above may be modified in various ways. Specific modifications which can be applied to the above-described embodiments are exemplified below. Two or more modifications desirably selected from the following examples may be appropriately combined within a range in which the selected modifications do not conflict with one another.

(1) In each of the above-described embodiments, the configuration of the ejecting unit 40 is desirably determined. For example, a configuration including another element that differs from the channel substrate 32, the pressure chamber substrate 34, the vibrating plate 36, and the piezoelectric element 38; or a configuration in which the channel substrate 32 is integrated with the pressure chamber substrate 34 may be employed.

In each of the above-described embodiments, the configuration in which the first electrode 51 is an individual electrode and the second electrode 53 is a common electrode is exemplified; however, the first electrode 51 may be a common electrode that continues over the plurality of piezoelectric elements 38, and the second electrode 53 may be a separate individual electrode for each piezoelectric element 38. Further, both of the first electrode 51 and the second electrode 53 may serve as individual electrodes. With the configuration in which the first electrode 51 is a common electrode and the second electrode 53 is an individual electrode, the support portion 60 is in contact with a surface of the first electrode 51. Moreover, with the configuration in which both the first electrode 51 and the second electrode 53 serve as individual electrodes, the support portion 60 is in contact with the surface of the vibrating plate 36. As understood from the above description, a portion of the ejecting unit 40 with which the support portion 60 is in contact may be appropriately changed in accordance with the configuration of the ejecting unit 40.

(2) In each of the above-described embodiments, the shape of the support portion 60 is desirably determined as long as the width of the portion of the support portion 60 that is in contact with the ejecting unit 40 is larger than the width W1 of the wall portion 341. For example, the width W0 may increase continuously or stepwise from the portion near the ejecting unit 40 toward the portion near the protection substrate 44. Alternatively, the width W0 of the portion of the support portion 60 other than the portion that is in contact with the ejecting unit 40 may be smaller than the width W1 of the wall portion 341.

(3) In each of the second and third embodiments, the support portion 60 includes the first portion 61 and the second portion 62; however, the support portion 60 may include another element that differs from the first portion 61 and the second portion 62.

(4) The driving element that causes a liquid (for example, an ink) in the pressure chamber C to be ejected from the nozzle N is not limited to the piezoelectric element 38 illustrated in each embodiment. For example, a heat generating element that generates air bubbles in the pressure chamber C by heating to vary the pressure may be used as the driving element. As understood from the above-described example, the driving element is generally expressed as an element that ejects the liquid in the pressure chamber C from the nozzle N (typically, an element that applies a pressure to the inside of the pressure chamber C), and its operation type (piezoelectric type/thermal type) and its specific configuration are desirably determined.

(5) In each of the above-described embodiments, the serial liquid ejecting apparatus 100 in which the transport body 242 at which the liquid ejecting head 26 is mounted reciprocates is exemplified; however, the present disclosure can be also applied to a line liquid ejecting apparatus in which a plurality of nozzles N are distributed over the entire width of a medium 12.

(6) The liquid ejecting apparatus 100 exemplified in each of the above-described embodiments may be employed in various apparatuses such as facsimile apparatuses and copying machines in addition to apparatuses dedicated to printing. Note that the purpose of use of the liquid ejecting apparatus of the present disclosure is not limited to printing. For example, a liquid ejecting apparatus that ejects a solution of a coloring material is used as a manufacturing apparatus that forms a color filter of a liquid crystal display device. Moreover, a liquid ejecting apparatus that ejects a solution of a conductive material is used as a manufacturing apparatus that forms wiring or electrodes of wiring substrates.

What is claimed is:

1. A liquid ejecting head comprising:
an ejecting unit including
a first pressure chamber communicating with a first nozzle that ejects a liquid,
a second pressure chamber communicating with a second nozzle that ejects the liquid,
a first wall portion separating the first pressure chamber and the second pressure chamber,
a first driving element that varies a pressure of the first pressure chamber, and
a second driving element that varies a pressure of the second pressure chamber;
a protection substrate disposed at the ejecting unit on a side opposite to the first nozzle and the second nozzle; and
a support portion formed to extend from a surface of the protection substrate on a side near the ejecting unit to the ejecting unit, wherein
the support portion overlaps the first wall portion in plan view in a direction perpendicular to the protection substrate, and a portion of the support portion that is in contact with a surface of the ejecting unit has a larger width than a width of the first wall portion.

2. The liquid ejecting head according to claim 1, wherein
the support portion has a larger Young's modulus than a Young's modulus of the protection substrate.

3. The liquid ejecting head according to claim 1, wherein
the ejecting unit further includes
a vibrating plate defining a portion of a wall surface of the first pressure chamber and a portion of a wall surface of the second pressure chamber, and
a distance between the protection substrate and the vibrating plate increases the farther away from the support portion along a direction parallel to the vibrating plate.

4. The liquid ejecting head according to claim 1, wherein
the ejecting unit further includes
a first communication channel causing the first nozzle to communicate with the first pressure chamber,
a second communication channel causing the second nozzle to communicate with the second pressure chamber, and
a second wall portion separating the first communication channel and the second communication channel, and
the second wall portion overlaps the first wall portion in plan view in a direction perpendicular to the protection substrate, and a portion of the second wall portion that is in contact with the ejecting unit has a larger width than a width of the first wall portion.

5. The liquid ejecting head according to claim 1, wherein
the first piezoelectric element and the second piezoelectric element each are a thin-film piezoelectric element including a first electrode, a piezoelectric layer, and a second electrode stacked on one another,
a first voltage is supplied to one of the first electrode and the second electrode, and
a drive waveform is supplied to the other one of the first electrode and the second electrode, the drive waveform being a drive waveform with which a voltage varies from a second voltage that differs from the first voltage.

6. The liquid ejecting head according to claim 5, wherein
the support portion has a higher thermal conductivity than a thermal conductivity of the piezoelectric layer.

7. The liquid ejecting head according to claim 1, wherein
the support portion is formed of a photosensitive resin.

8. A liquid ejecting apparatus comprising:
the liquid ejecting head according to claim 1, the liquid ejecting head being at least one liquid ejecting head; and
a drive circuit that drives the liquid ejecting head.

9. The liquid ejecting apparatus according to claim 8, wherein
the liquid ejecting head has an ejection surface in which the first nozzle and the second nozzle are formed, and
the liquid ejecting apparatus further comprises
a wiper that wipes the liquid adhering to the ejection surface.

10. The liquid ejecting apparatus according to claim 8, wherein
the liquid ejecting head has an ejection surface in which the first nozzle and the second nozzle are formed, and
the liquid ejecting apparatus further comprises
a sealing body that is in contact with the ejection surface and seals the first nozzle and the second nozzle and
a pump that sucks inside of the sealing body.

11. The liquid ejecting apparatus according to claim 8, wherein
the at least one liquid ejecting head includes a plurality of liquid ejecting heads, and
the plurality of liquid ejecting heads are arranged in parallel to one another in a direction intersecting with a direction in which the first nozzle and the second nozzle are arranged.
